(19) United States
(12) Patent Application Publication
(10) Pub. No.: US 2003/0066828 A1
(43) Pub. Date: Apr. 10, 2003

(54) Method of producing electrically resistive heating elements composed of semi-conductive metal oxides and resistive elements so produced

(76) Inventor: Jeffery Boardman, Warrington (GB)

Correspondence Address: CASELLA & HESPOS, 274 MADISON AVENUE, NEW YORK, NY, 10016

(21) Appl. No.: 10/148,574

(22) PCT Filed: Dec. 8, 2000
(86) PCT No.: PCT/GB00/04680

(30) Foreign Application Priority Data
Dec. 10, 1999 (GB) 9929095.9

(51) Int. Cl. H05B 3/16

(52) U.S. Cl. 219/543; 219/548; 219/553

(57) ABSTRACT

A method of producing semi-conductive, electrical resistive heating elements comprising metal oxides, preferably binary metal oxides whereby the two metals are of different valencies and the conductivity of the binary oxide system is determined by the compositioned ratio of the two metals having different valencies and the degree of oxidation, and electrically resistive heating elements so produced.

The present invention is concerned with electrically resistive heating elements and a method of fabricating such elements.

It is known that electrically resistive heating elements comprising a resistive track can be formed either by laying the resistive track directly onto an electrically conductive substrate or onto an insulating layer carried by the electrically conductive substrate. The present invention is applicable to both of the latter structures.

In the case of electrically resistive heating elements of the first type wherein the resistive track is laid directly onto a conductive substrate, two conventional fabrication techniques are known.

The first method is to screen print a resistive track in a variety of configurations onto a suitably prepared thermally and electrically conductive substrate, which in this case is invariably metal.

In this process an insulating layer is firstly applied to the conductive surface which is to receive the resistive track. The insulating layer is generally of a material type compatible in properties with both the conductive metal substrate and the resistive element. It may be applied to the conductive metal substrate in a variety of ways but is generally done by screen printing using two or more steps, each consisting of a printing, drying and firing operation.

The use of multiple steps in the application of the dielectric insulating layer to the conductive supporting substrate is intended to eliminate the chance of defects in any one layer coinciding with defects in either a preceding or succeeding layer, and causing the dielectric layer to lose its insulating properties.

With the successful provision of a dielectric insulating layer onto the electrically conductive supporting substrate, the required electrically resistive tracks may be screen printed onto the dielectric layer to form an electrical element of the required configuration. To ensure uniformity of properties for the resistive element, the track configuration is generally applied in several stages. The material comprising the matrix within which the resistive component is suspended needs to match the properties of the preceding insulating layer.

The second method comprises the deposition, by flame spraying, of a metal oxide or oxides onto an electrically conductive supporting substrate. Such substrate also incorporates an electrically insulating dielectric layer, applied to the surface to which the electrically resistive oxide is to be applied by flame spraying to form the electrical heating element, generally as described in patents EU302589, U.S. Pat. No. 5,039,840 and patent application No. PCT/GB96/01351 to which reference is directed. A supporting substrate is required for both types of elements produced by the precedingly described processes as the materials forming the electrically resistive elements do not have sufficiently high intrinsic strengths to be self-supporting.

Whilst both processes may be used to produce elements using electrically non-conductive materials such as fired ceramics as the supporting substrate, experience has shown that such systems are both more expensive and less robust in use than those employing insulated electrically conductive metal substrates.

The requirement for an electrically insulating dielectric layer between the element and conductive metal substrate arises almost entirely from the low resistivities of the materials used to form the electrically resistive element components.

As an example, the resistive materials used in the firstly described process, that of multi-layer screen printing, are generally based on silver palladium compounds, with resistivities in the region of 10 to 160 mΩ square for thicknesses of 20 μm.

This requires the elements produced from this process to be configured in the form of tracks of appreciable length.

Whilst the resistivities of the metal oxides produced by the second method are higher, ranging from 100 to 3000 ohm mms, the elements so produced do need to have a track length greater than their thickness by a large ratio.

The deposition of either type of electrically resistive material previously described directly to a supporting electrically conductive metal substrate would result in failure on the application of an electrical supply. The electrical current would flow from one contact point directly through the resistive layer to the metal substrate and subsequently along the shortest path through the metal and up through the resistive layer to the other point of contact.

This catastrophic form of failure may be readily seen in either type of element where the dielectric layer between resistive track and substrate metal is sufficiently defective to allow the passage of current in the form of a small hole whose surroundings show evidence of high temperature.

Whilst the two aforementioned methods are effectively and successfully used to manufacture electrical elements they are subject to various constructional disadvantages and the elements so produced to several operational disadvantages, some of which are listed below.

For both methods, the material used to form the insulating dielectric layer must be compatible with both the type of metal used for the supporting substrate and the resistive layer applied to it.

This compatibility usually requires the metal and dielectric material to have matching, or nearly matching, coefficients of thermal expansion and good adhesion one to the other.

With the oxidised flame spray method the metal substrate material may be aluminium, copper, mild or stainless steel with alumina, alumina titania, magnesia, or any combination of insulating metal oxides, or even an enamel or glass ceramic used as the dielectric/insulating layer.

However the screen printed element technology is restricted to a glass ceramic dielectric material, which in turn is compatible with virtually only one type of ferritic stainless alloy.

For all the above metal and insulation material combinations, the adhesion is dependent upon some form of metal surface pre-treatment and chemical bonding mechanism. Failure to achieve the requisite metal to insulation bond will result in element failure where separation occurs.

Similarly a mis-match in the coefficients of thermal expansion between the supporting metal substrate and the dielectric layer material will induce tensile stresses in the less ductile layer during thermal cycling whilst in use. The least ductile material is inevitably the dielectric layer and the effect of the stresses resulting from thermal cycling is to cause micro cracking of the insulating layer, with consequent loss of dielectric properties and subsequent failure of the element system.

The prime requirement of the intermediate layer is that it provides sufficient electrical insulation between the resistive element track and the metal substrate to meet the appropriate requirements of the various standards used to determine the safe operating conditions and properties of the various types of elements and associated applications.

Whilst such insulating materials may have high dielectric properties, a defect or hole in one part or area beneath the resistive element track will result in either failure in service or non-compliance with the appropriate regulations and standards.

To avoid such defects it is customary to apply the insulating material to the metal substrate in a series of thin layers. As a result, the deposition of the dielectric layer is a multi-stage process, generally requiring high energy input at each stage.

In consequence, the production of the insulating layer is comparatively expensive and can constitute the major cost component for the manufacture of the appropriate element system.

In general, materials with good dielectric properties inevitably have low thermal conductivities. As a result they act as barriers to the transmission of heat energy from the point of origin at the resistive element layer to the point of dissipation and utilisation at the outer surface of the metal substrate. For some metal and dielectric systems the thermal conductivity of the insulating layer effectively determines the operating conditions for the whole element system. It is not unknown for a metal substrate to water interface to be at only 104° C. whilst the element operating temperature is in excess of 250° C., due entirely to the poor thermal conductivity of the insulating layer.

This effect has deleterious operational implications for the efficiencies and use of such elements. High operating temperatures can limit the types of materials to be used to contain them or require the provision of thermal barriers. Where such elements may be used with low melting point plastic containment materials, there is a fire and safety risk if uncontrolled.

The conflict of requirements for a dielectric material thick enough to meet the insulation standards and yet thin enough to provide good thermal conductivity is a continuing problem for manufacturers of the two aforementioned types of elements.

The present invention seeks to overcome or substantially reduce the problems described above associated with the known element systems and manufacturing techniques.

In accordance with the present invention in its broadest aspect, there is provided an electrically resistive heating element comprising a semi-conductive metal oxide layer formed from an oxidised alloy comprising metals having different valencies such that the resulting oxide matrix conducts by virtue of an electron surplus in the upper energy band [“n” type] or an electron deficit in the lower energy band [“p” type] of the atomic structure comprising the oxide matrix.

In some embodiments, the alloy comprising metals having different valencies has a composition such that the majority component is bivalent, trivalent, quadrivalent or pentavalent, and the corresponding respective minority component is monovalent, bivalent, trivalent or quadrivalent, and such that the oxidised matrix or the binary alloy so formed has an electron deficiency in the lower energy band of the atomic structure comprising the oxide matrix and consequently exhibits, “p” type electronic conduction.

In some other embodiments, the alloy comprising metals having different valencies has a composition such that the majority component is monovalent, bivalent, trivalent or quadrivalent, and the corresponding respective minority component is bivalent, trivalent, quadrivalent or pentavalent and, such that the oxidised matrix of the binary alloy so formed has an electron surplus in the upper energy band of the atomic structure comprising the oxide matrix and consequently exhibits “n” type electronic conduction.

Advantageously, the alloy comprising metals having different valencies can in some cases also incorporate other elements or combinations of elements which assist in the oxidation process and enhance the formation of an electron surplus in the upper energy band or an electron deficiency in the lower energy band of the atomic structure comprising the oxide matrix.

The structure of the oxide matrix may be crystalline or amorphous, both forms having upper and lower energy bands differentially populated according to chemical composition.

The percentage degree of oxidation of a metal alloy powder consisting of metals having different valencies necessary to provide the requisite number of current carriers can be calculated from a knowledge of the alloy composition and the operating conditions of electrical power and applied voltage and resistive semi-conductive oxide layer dimensions of thickness and area as is given in the example calculation detailed in Example A described hereinafter.

The alloy of metals of different valencies may be in any size of wire, rod or powder form as may be considered convenient for use in the oxidising and layer deposition processes and that the powders in particular may have powder particle size ranges from 500 μm (microns) down to 1 μm or even submicron dimensions or any subsize range within the overall maxima and minima.

The oxidation and subsequent layer deposition processes to be used to construct electrically resistive devices from alloys of metals of different valencies may be done separately such that the alloy in either wire, rod or powder form may be firstly oxidised to a predetermined degree and then deposited by a second process or oxidised to the required degree during the actual layer deposition process.

For the performance of this present invention, the degree of particle pre-oxidation is preferably such that the whole mass of each particle is not normally fully oxidised, but rather that there usually remains a metallic region within the surrounding oxidised layer or at the nucleus of each particle.

In some embodiments, the electrically resistive heating element can comprise an electrically conductive substrate, said semi-conductive metal oxide thermally sprayed onto at least part of one surface of the conductive substrate, and a contact portion disposed over the majority of the semi-conductive oxide area such that an electric current may be passed from the contact portion on one side through the thickness of the semi-conductive oxide layer to the conductive substrate on the other, electrical connection being made firstly to the contact portion and secondly to the conductive substrate, whereby heat is generated within the volume of the semi-conductive oxide matrix as a result of the passage of said electrical current.

The contact portion can comprise a layer of a conductive material which has been applied by means of flame spraying, chemical vapour deposition or magnetron sputtering technique, electrolytic or chemical processes, or comprises a solid piece held in place with adhesives, mechanical pressure or magnetic means.

Preferably said conductive material is any of copper, nickel, aluminium, gold, silver, brass or conductive polymers.

Advantageously, the contact portion is smaller in area, than the semi-conductive oxide layer so as to leave a distance between the outer edge of the contact layer and the outer edge of the semi-conductive oxide layer, sufficient to prevent an electrical current passing directly from the contact area to the conductive substrate when a voltage is applied between contact and substrate.

The conductive substrate can comprise, for example, an electrically conductive metal, non-metal or metal alloy having either a flat two dimensional or a three dimensional curved form and of a sufficient thickness to provide dimensional stability for the heating element system during the production process and subsequent operational use.

In some embodiments the contact portion has a thickness enabling it to carry the maximum current required and allow it to distribute evenly over the whole of its surface such that the current passing through the semi-conductive oxide layer from contact to metal substrate is uniform in density for each unit area of the semi-conductive oxide. This provision ensures that the heat energy generated per unit area is uniform and consequently the semi-conductive oxide matrix develops a uniform temperature without any localised hot spots.

Advantageously, but not essentially, the area of the contact portion to which an external power point is to be fixed is thicker than the remaining areas to assist the even distribution of the current.

The semi-conductive oxidised layer may be considered to consist of strings of inter-connecting oxidised particles extending through the oxide layer. Each string of oxidised particles may be considered as a “wire” and hence the resistive oxidised layer may be considered as being composed of a multitude of parallel “wires”, each wire carrying an appropriate fraction of the overall current.

The measured resistance of the semi-conductive oxide system is effectively the sum of the resistances of all the parallel “wires”, or particle strings, connecting the contact area to the metal substrate.

In other embodiments, the electrically resistive heating element can comprise a substrate formed of an electrically insulating material or formed of an electrically conductive material provided with an electrically insulating coating, whereby in both cases the substrate presents an electrically non-conductive surface on at least one side, first and second laterally spaced contact areas disposed over said electrically non-conductive surface and said thermally sprayed semi-conductive oxide layer applied to at least part of said electrically non-conductive surface and disposed over or under at least parts of said contact areas to enable an electric current to be passed through the resistive oxide layer via said first and second contact areas.

Oxidation and subsequent layer deposition processes used to construct the electrically resistive heating element from the alloy having metals of different valencies can be performed separately in that the alloy in either wire, rod or powder form is firstly oxidised to a predetermined degree and then deposited by a second process or oxidised to the required degree during an actual layer deposition process.

The pre-oxidation process for the alloy having metals of different valencies in wire, rod or powder form can be accomplished by heating the alloy within a furnace under the influence of an oxidising atmosphere for a required time at a selected temperature, the time/temperature relationship being determined by empirical methods or by reference to bibliographic sources.

The oxidation process can comprise passing the binary alloy in wire, rod or powder form through a heating source in the presence of an excess of oxygen, such that the wire, rod or powders become molten or semi-molten and react with the excess oxygen to the required degree and the oxidation reaction is then stopped by quenching the molten or semi-molten particles.

The quenching step can be achieved by quenching the molten or semi-molten particles in a bath of water or other liquid into which the molten or semi-molten particles pass after leaving the heating source.

The appropriate conditions regarding the temperature of the heating source, the excess of oxygen present and the reaction time of the molten or semi-molten form of the binary alloy with the excess of oxygen to form the appropriate degree of oxidation may be determined by empirical methodology or calculation from suitable bibliographic sources.

The heating source can comprise, for example, an oxygen fuel flame or an electrical heater.

The process for the deposition of the previously oxidised alloy comprising metals having different valencies to form an electrically resistive layer onto a conductive metal substrate may take several forms including the sintering together of the required mass of oxidised alloy particles under an inert or slightly oxidising atmosphere where the required mass of oxidised alloy particles has been previously mixed with a binding medium of convenient form, for example methyl silicone or cellulose, and compressed to predetermined dimensions and density.

Advantageously, the deposition of the previously oxidised particles onto the substrate is achieved by means of a thermal spraying technique under the influence of an inert or slightly oxidising atmosphere.

The thermal spraying technique can comprise for example any of plasma, high velocity oxy-fuel, the wire process and oxy-fuel flame spraying deposition processes.

In some embodiments, the oxidation and deposition steps used to construct the electrically resistive heating element from the alloy comprising metals having different valencies to form an electrically resistive layer are combined into one operation whereby the alloy is passed through a heating source so as to form molten or semi-molten particles and wherein associated with the heating source is an atmosphere containing excess oxygen such that the molten or semi-molten particles of the oxide react with the excess of oxygen to form the required degree of oxidation on their surfaces prior to impacting onto the conductive or insulative substrate to form a resistive layer which has the required conductivity predicted by calculation to operate as a heating source for a specific use and purpose, the conductivity arising from the valency difference of the metals constituting the alloy and the degree of oxidation achieved by the prementioned process.

The various process operating conditions regarding the temperature of the heating source amount of excess oxygen and reaction time to produce the required degree of oxidation for the molten or semi-molten binary oxide particles may be determined by empirical methodology or reference to suitable bibliographic sources.

The combined oxidation and deposition process can, for example, take the form of a combination of a heat source and an atmosphere containing excess oxygen.

The combined oxidation and deposition process can be carried out, for example, by a thermal spraying technique, including any of plasma, high velocity oxy-fuel, wire or rod, and oxy-fuel spraying deposition processes.

Preferably, the composition of the alloy comprising metals having different valencies is such that the majority components are present at levels of 80%-98% and the respective minority components at levels of 20%-2% and that a particular alloy consists of any combination between these values.

The contact area disposed over the majority of the semi-conductive oxide layer area can be deposited by any of thermal spraying techniques, physical and chemical vapour deposition in a vacuum, evaporated metals using electron beam or thermal techniques, electroless and electrolytic processes and mechanical pressure methods.

The alloy comprising metals having different valencies may also incorporate other elements or combinations of elements, such as silicon, which advantageously assist in the oxidation process and enhance the formation of an electron surplus in the upper energy band or an electron deficiency in the lower energy band of the atomic structure comprising the oxide matrix.

Increasing the degree of oxidation of the alloy comprising metals having different valencies increases the number of electronic charge carriers available to provide electronic conductive properties thus decreasing the resistivity of the oxide matrix and the resistance of an oxidised deposit acting as an element, whereas increasing the degree of oxidation of the resistive materials used in the pre-mentioned conventional methods of producing electrical elements also increased the resistivity of the matrix and the resistance of the layer acting as an element.

Preferably, the compositions of the alloy comprising metals having different valencies are such that the pre-mentioned majority components are present at levels of 80%-98% and the respective minority components at levels of 20%-2% and that a particular alloy may consist of any combination between these values.

Preferably, the alloy is a binary alloy consisting of two metals only.

Typical examples of binary alloys can include, for example:-

| Majority component | Minority component |
|---|---|
| Ni⁺² | L₁⁺¹ |
| Al⁺³ | N_{c}⁺² |
| Cu⁺² | L₁⁺¹ |
| La⁺³ | N₁⁺² |
| La⁺³ | Cu⁺² |
| Fc⁺³ | Ni⁺² |
| Mn⁺⁴ | Al⁺³ |

The present technique can enable the construction of semi-conductive electrically resistive heating elements comprised of a substrate onto which are deposited layers of a binary metal oxide wherein the two metals are of different valencies and the conductivity of the resulting binary oxide system is determined by the compositional ratio of the two metals having different valencies and the degree of oxidation, and electrically conductive contact layers such that the current carrying paths extend from one contact longitudinally through the binary resistive oxide layer to a second contact, or alternatively through the thickness of the binary resistive oxide layer from the electrically conductive substrate to an electrically conductive contact layer.

Advantageously, the particles of the binary metal alloy are oxidised such that the composition of the resulting oxide system so produced has the same ratio as the original binary metal alloy, ie. the ratio of the amounts of the oxides of the metal is the same as the ratio of the amounts of the metals in the original binary alloy.

Preferably, the surface of a suitable metal supporting metal substrate is pre. prepared such that the surface is substantially chemically clean and to which will adhere either an electrically insulating layer or molten oxidised particles.

the oxidised binary alloy particles are heated to a temperature at which they become molten or semi-molten, the heated particles being deposited onto said surface of the supporting substrate to form an electrically resistive layer, either directly or additionally to a previously applied insulating layer.

The resistivity of the electrically resistive oxide layer may be adjusted by varying the degree of oxidation of the binary alloy metal particles.

An increase in the degree of oxidation of the binary alloy particles consisting of metals having different valencies will increase the number of electronic charge carriers available to provide electronic conduction thus decreasing the resistivity of the oxide matrix.

The binary alloy powder particles composed of two metals of different valencies may be of any size range from 1 micron or below to 500 microns an may be of any shape, uniform or irregular, spherical or having re-entrant angles.

Combinations of resistive oxide and conductive contact layers may be applied to suitably prepared supporting substrates in either flat, tubular or spherical form, or of any shape for which a mathematical equation may be derived and used to control a robotic device capable of holding either the heat source used to deposit the oxidised particles onto the surface of said suitably prepared supporting substrate, or the said suitable prepared supporting substrate.

The electrically resistive oxide deposit consisting of binary oxides derived from a combination of metals having different valencies may have “n” or “p” type conductive properties and a variety of temperature resistance coefficients ranging from negative through neutral to positive.

The invention is described further hereinafter, by way of example only, with reference to the accompanying drawings, in which:

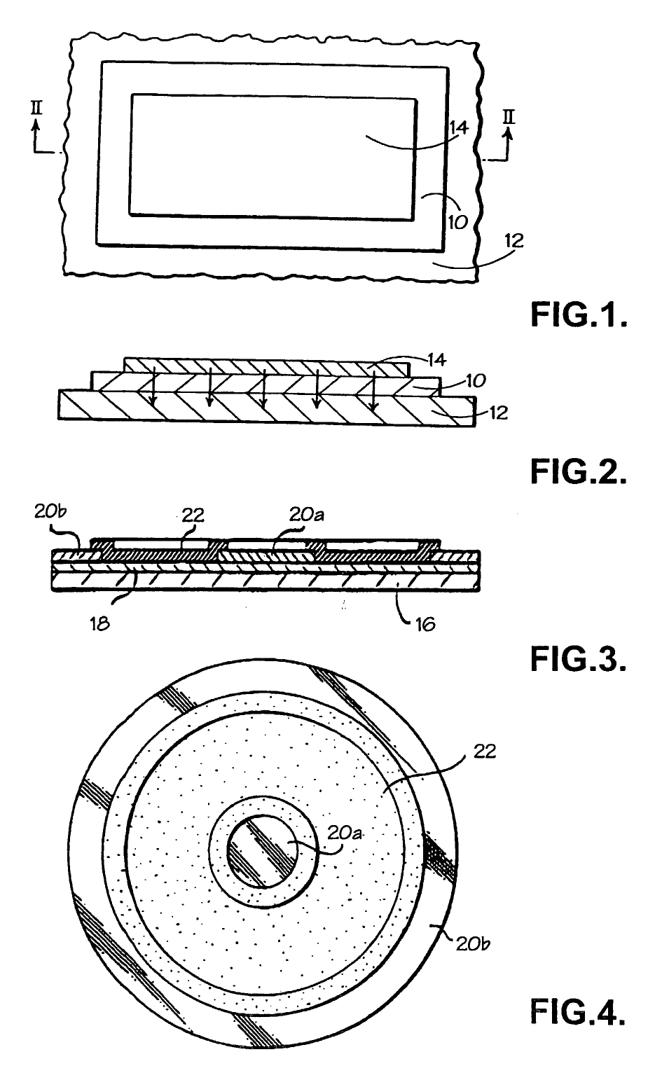

FIG. 1 is a diagrammatic plan view of an example of a resistive heating element in accordance with the present invention;

FIG. 2 is a section of I-I in FIG. 1; and

FIGS. 3 and 4 are highly schematic inverted, sectional side and plan views illustrating diagrammatically the construction of a second embodiment of a resistive heating element in accordance with the present invention.

The embodiments of FIGS. 1 and 2 comprises an electrically resistive oxide layer 10 formed on a conductive metal substrate 12 and carrying an electrically conductive contact layer 14. In this case, the resistive layer 10 and contact layer 10, 14 are both rectangular and the conductive metal substrate is a flat/planar plate. In other embodiments the substrate could equally well be tubular or indeed any shape definable by a mathematical equation. Again, the overall shape of the substrate could be any desired configuration, eg. square, rectangular, round.

The current flow from the contact layer to the conductive substrate, or vice versa, can be considered to be by way of a plurality of generally parallel, linear paths of oxide covered metal particles as indicated diagrammatically by the parallel lines 16.

In FIGS. 3 and 4 where, for the purposes of illustration, the thickness of the various layers are exaggerated and not to scale, the second embodiment comprises a substrate 16, manufactured from metal, or other material, having good thermally conductive properties and being processed/formed into the shape required to form the bottom of a liquid heating vessel, or capable of being readily attached to the base of such vessel. In FIGS. 3 and 4, the substrate is shown as being circular but it could in principle be any desired shape.

Copper is usually preferred as the material for the substrate 16, since the coefficient of thermal heat transfer is 377 watts/metre/° Kelvin, which is well in excess of that of stainless steel at only 18 watts/metre/° Kelvin. The substrate 16 is usually produced, as a circular planar disc, of diameter suitable for attachment to, or installtion in, a relevant liquid heating vessel. The substrate disc may be completely flat or be profiled, for example with a flanged rim for assisting assembly with the other parts of the vessel.

To one side of the substrate 16 (the upper side as shown in the inverted view of FIG. 3, but the underside in practice) there is applied a dielectric (electrically non-conductive/insulating) layer 18, of a sufficient thickness as to be capable of withstanding, without breakdown, a prescribed voltage V between the metal substrate 16 and the outer surface of the dielectric layer 18. In a typical case the prescribed voltage V is of the order of 4000 volts.

The dielectric layer 18 may consist of a suitable vitreous enamel, typically having a thickness in the region of 100 μm in order to achieve the abovementioned voltage breakdown capability. The dielectric layer 18 can be applied-in either one, or a succession of steps or it may consist of a series or combination of thermally sprayed metal oxides, such as alumina, titania or magnesia, again typically having a total thickness in the region of 100 μm.

The thermal conductivity of the dielectric layer 18 may be enhanced in some cases by the admixture to it of other ceramic materials, having equivalent or better dielectric properties but with better thermal conductivities. Examples of such other ceramic materials include the nitrides of boron and aluminimun.

Onto the dielectric layer 18 are applied element contact areas 20. In the example of FIGS. 3 and 4, the contact areas comprise a centrally disposed, circular contact area 20a and a peripherally disposed, annular contact area 20b. These contact areas 20a, 20b are provided for the purpose to enable an electrical current to be passed through the next to be applied, electrically resistive heating element described further hereinafter.

The contact areas 20a, 20b can be applied to the dielectric layer 18 by any suitable chemical or physical deposition technique, such as vacuum deposition. magnetron sputtering, electroless deposition, screen printing or any form of thermal spraying technique. The contact areas may consist of one or a combination of those metals such as silver, gold, copper, aluminium and nickel, which are known to have excellent electrical conducting properties. The thickness of the metal contact areas need only be such as is required to carry the operating current of the liquid heating element described hereinafter, which is usually up to a typical maximum of 15 amps but could in practice be much higher.

The size and configuration of the contact areas 20a, 20b are established such that they will, if necessary accommodate an operating temperature limiting device (not shown).

An electrically resistive element 22, as described hereinbefore, is then applied to the exposed surface of the dielectric layer 18 so as to cover the area between the two contact areas 20a, 20b and to overlap these contact areas at least partially.

### EXAMPLE A

### DESIGN FOR A SEMI-CONDUCTING HEATING DEVICE

Power output=3.1 Kw @ 240 v, 12.917 Amps & 18.58 Ohms.

Device heating area 90 cm²

Properties per unit area of 1 cm²

| Total | Watts/ | Amps/ | Electrons/ |
|---|---|---|---|
| Power | cm² | cm² | cm² |
| 3100 Watts | 34.44 | 0.1435 | 2.299 × 10¹⁸ |

Resistive S/C layer thickness 200 μm

Volume of S/C—“n” type consisting of a bivalent majority matrix with a minority trivalent dopant—Vol/unit area=0.02 cm³

Commercially available bivalent/trivalent alloy 95% Ni, 5% Al, with a density of 8.59 Gm/cm³, Ni being bivalent majority component and Al being trivalent minority component.

Assume model composition of S/C to be of the form 0.95xNi+0.05xAl+xO. Properties of elements:

| Element | Ni | Al | Oz |
|---|---|---|---|
| Valency | 2 | 3 | — |
| Density G/cm³ | 8.9 | 2.7 | 0.53 |
| Atomic Wt | 58.71 | 27 | 16 |
| Atomic No | 28 | 13 | 8 |
| Atomic Mass Gms | 97.5 | 44.84 | 26.57 × 10⁻²⁴ |

Based on an Atomic No of Hydrogen of 1.008 and weight of 1.674×10⁻²⁴ Gms

NOTE: S/C denotes semi conductive oxide PPSR denotes powder particle size range

Based on model composition, S/C oxide average density is:

0.475 Ni+0.025 Al+0.502 (1)

Calculated as 4.56 Gm/cm³

Weight of oxide in a unit volume of 1 cm²×0.02 cm thick=0.0912 Gms

Calculated average atomic mass of the S/C composition is 60.72×10⁻²⁴ grammes.

NOTE: The characteristics of these S/C oxides are governed by the oxide interfaces.

The number of electrons required for conduction per unit volume is 2.299×10¹⁸

The resistive S/C oxide layer is produced by thermally spraying the Ni Al alloy metal powder under carefully controlled conditions using relatively simple but robust specially designed spray equipment.

Normal P.P.S.R. is −110 μm to +40 μm of non-spherical profiles.

On heating during the process, the particles become molten and change to a spherical shape, average means size of

65 μm diameter volume of 65 μm dia=1.4379×10⁻⁷ cm³

On impact with the surface to be coated the spheres are reduced to platelets, of average thickness of 40 μm and an area of 3.596×10⁻⁵ cm². No of particles per 40 μm layer per cm² of deposit is approx 27800. No of layers for a total thickness of 200 μm at an average platelet thickness of 40 μm=5, giving 10 oxide interfaces.

As the particles are thermally sprayed under the correct conditions the S/C oxide forms on the particle surface.

Let the degree of oxidation be “X”. The number of free electrons per cm² required for conduction is 2.299×10¹⁸.

Based on equation (1) it requires 40 atomic combinations to produce one free electron. So weight of 40 atomic combinations=40×60.72×10⁻²⁴ grammes.

Weight of S/C oxide required to produce 2.299×10¹⁸ free electrons is 40×60.72×10⁻²⁴×2.299×10¹⁸−5.583×10⁻³ gms.

Based on a calculated density of 4.56 Gms/cm³ the volume of oxide required is 1.225×10⁻³ cm³.

Calculated volume of deposit per cm² at 200 μm=0.02 cm³

Degree of oxidation of sprayed particles required to produce the-required semi conductive properties as calculated is

$$\frac{1.225 \times {10}^{- 3}}{2.0} = \frac{6.1 \%}{}$$

From this example it may be seen that an A/C reactive semi-conductor heating device may be produced by thermally spraying and oxidising a commercially available metal alloy powder to a predictable level.

In practice it is usual to oxidise to a higher degree of, say, 10%, which is a more controllable figure for the following reasons.

The sprayed deposits are not usually 100% dense—as assumed—and the presence of microscopic pores constricts the direct flows of electrons whilst increasing the resistivity.

this is not detrimental as it has been found advantageous to spray a deposit some 10% thicker than ideally required, measure the sprayed unit area resistance and then use a finishing operation to adjust the S/C oxide thickness to the required resistance value.

This “finishing” operation allows S/C oxide layers to be held within closer limits than are available with current element technology of ±2½% quite easily.

1. An electrically resistive heating element comprising a semi-conductive metal oxide layer formed from an oxidised alloy comprising metals having different valencies such that the resulting oxide matrix conducts by virtue of an electron surplus in the upper energy band or an electron deficit in the lower energy band of the atomic structure comprising the oxide matrix.

2. An electrically resistive heating element as claimed in claim 1, wherein the alloy comprising metals having different valencies has a composition such that the majority component is bivalent, trivalent, quadrivalent or pentavalent, and the corresponding respective minority component is monovalent, bivalent, trivalent or quadrivalent and such that the oxidised matrix or the binary alloy so formed has an electron deficiency in the lower energy band of the atomic structure comprising the oxide matrix and consequently exhibits “p” type electronic conduction.

3. An electrically resistive heating element as claimed in claim 1, wherein the alloy comprising metals having different valencies has a composition such that the majority component is monovalent, bivalent, trivalent or quadrivalent, and the corresponding respective minority component is bivalent, trivalent, quadrivalent or pentavalent and, such that the oxidised matrix of the binary alloy so formed has an electron surplus in the upper energy band of the atomic structure comprising the oxide matrix and consequently exhibits “n” type electronic conduction.

4. An electrically resistive heating element as claimed in any of claims 1 to 3, wherein the alloy comprising metals having different valencies also incorporates other elements or combinations of elements which assist in the oxidation process and enhance the formation of an electron surplus in the upper energy band or an electron deficiency in the lower energy band of the atomic structure comprising the oxide matrix.

5. An electrically resistive heating element as claimed in any of claims 1 to 4, wherein the structure of the oxide matrix is crystalline.

6. An electrically resistive heating element as claimed in any of claims 1 to 4, wherein the structure of the oxide matrix is amorphous.

7. An electrically resistive heating element as claimed in any of claims 1 to 6, wherein the alloy having metals of different valencies may be in any size of wire, rod or powder form for use in oxidising and layer deposition processes.

8. An electrically resistive heating element as claimed in any of claims 1 to 7, comprising an electrically conductive substrate, said semi-conductive metal oxide thermally sprayed onto at least part of one surface of the conductive substrate and a contact portion disposed over the majority of the semi-conductive oxide area such that an electric current may be passed from the contact portion on one side through the thickness of the semi-conductive oxide layer to the conductive substrate on the other, electrical connection being made firstly to the contact portion and secondly to the conductive substrate, whereby heat is generated within the volume of the semi-conductive oxide matrix as a result of the passage of said electrical current.

9. An electrically resistive heating element as claimed in claim 8, wherein the contact portion comprises a layer of a conductive material which has been applied by means of flame spraying, chemical vapour deposition or magnetron sputtering techniques, electrolytic or chemical processes, or comprises a solid piece held in place with adhesives, mechanical pressure or magnetic means.

10. An electrically resistive heating element as claimed in claim 9, wherein said conductive material is any of copper, nickel, aluminium, gold, silver, brass or conductive polymers.

11. An electrically resistive heating element as claimed in claim 8, 9 or 10, wherein the contact portion is smaller in area than the semi-conductive oxide layer so as to leave a distance between the outer edge of the contact layer and the outer edge of the semi-conductive oxide layer, sufficient to prevent an electrical current passing directly from the contact area to the conductive substrate when a voltage is applied between contact and substrate.

12. An electrically resistive heating element as claimed in any of claims 8 to 11, wherein the conductive substrate comprises an electrically conductive metal, non-metal or metal alloy having either a flat two dimensional or a three dimensional curved form and of a sufficient thickness to provide dimensional stability for the heating element system during the production process and subsequent operational use.

13. An electrically resistive heating element as claimed in any of claims 8 to 11, wherein the contact portion has a thickness enabling it to carry the maximum current required and allow it to distribute evenly over the whole of its surface such that the current passing through the semi-conductive oxide layer from contact to metal substrate is uniform in density for each unit area of the semi-conductive oxide.

14. An electrically resistive heating element as claimed in claims 8 to 13, wherein the area of the contact portion to which an external power point is to be fixed is thicker than the remaining areas to assist in the even distribution of the current.

15. An electrically resistive heating element as claimed in any of claims 1 to 7, comprising a substrate formed of an electrically insulating material or formed of an electrically conductive material provided with an electrically insulating coating, whereby in both cases the substrate presents an electrically non-conductive surface on at least one side, first and second laterally spaced contact areas disposed over said electrically non-conductive surface and said thermally sprayed semi-conductive oxide layer applied to at least part of said electrically non-conductive surface and disposed over or under at least parts of said contact areas to enable an electric current to be passed through the resistive oxide layer via said first and second contact areas.

16. A method for forming a resistive heating element as claimed in any of claims 1 to 15, wherein oxidation and subsequent layer deposition processes used to construct the electrically resistive heating element from the alloy having metals of different valencies are performed separately in that the alloy in either wire, rod or powder form is firstly oxidised to a predetermined degree and then deposited by a second process or oxidised to the required degree during an actual layer deposition process.

17. A method for forming a resistive heating element as claimed in claim 16 wherein a pre-oxidation process for the alloy having metals of different valencies in wire, rod or powder form is accomplished by heating the alloy within a furnace under the influence of an oxidising atmosphere for a required time at a selected temperature.

18. A method for forming a resistive heating element as claimed in claim 16, wherein the oxidation process comprises passing the binary alloy in wire, rod or powder form through a heating source in the presence of an excess of oxygen, such that the wire, rod or powders become molten or semi-molten and react with the excess oxygen to the required degree and the oxidation reaction is then stopped by quenching the molten or semi-molten particles.

19. A method as claimed in claim 18, wherein the quenching step is achieved by quenching the molten or semi-molten particles in a bath of water or other liquid into which the molten or semi-molten particles pass after leaving the heating source.

20. A method as claimed in claim 18 or 19, wherein the heating source comprises an oxygen fuel flame or an electrical heater.

21. A method as claimed in any of claims 16 to 20, wherein the process for the deposition of the previously oxidised alloy consisting of metals having different valencies to form an electrically resistive layer onto a conductive metal substrate comprises the sintering together of the required mass of oxidised alloy particles under an inert or slightly oxidising atmosphere where the required mass of oxidised alloy particles has been previously mixed with a binding medium and compressed to predetermined dimensions and density.

22. A method as claimed in any of claims 16 to 20 wherein the deposition of the previously oxidised particles onto the substrate is achieved by means of a thermal spraying technique under the influence of an inert or slightly oxidising atmosphere.

23. A method as claimed in claim 22, wherein the thermal spraying technique comprises any of plasma, high velocity oxy-fuel, the wire process and oxy-fuel flame spraying deposition processes.

24. A method for forming a resistive heating element as claimed in any of claims 1 to 15, wherein oxidation and deposition steps used to construct the electrically resistive heating element from the alloy comprising metals having different valencies to form an electrically resistive layer are combined into one operation whereby the alloy is passed through a heating source so as to form molten or semi-molten particles and wherein associated with the heating source is an atmosphere containing excess oxygen such that the molten or semi-molten particles of the oxide react with the excess of oxygen to form the required degree of oxidation on their surfaces prior to impacting onto the conductive substrate to form a resistive layer which has the required conductivity predicted by calculation to operate as a heating source for a specific use and purpose, the conductivity arising from the valency different on the metals constituting the alloy and the degree of oxidation achieved by the prementioned process.

25. A method as claimed in claim 24, wherein the combined oxidation and deposition process takes the form of a combination of a heat source and an atmosphere containing excess oxygen.

26. A method as claimed in claim 25, wherein the combined oxidation and deposition process is carried out by a thermal spraying technique, including any of plasma, high velocity, oxy-fuel, wire or rod, and oxy-fuel spraying deposition processes.

27. A method as claimed in any of claims 16 to 26, wherein the composition of the alloy comprising metals having different valencies is such that the majority components are present at levels of 80% to 98% and the respective minority components at levels of 20%−2% and that a particular alloy consists of any combination between these values.

28. A method as claimed in any of claims 16 to 27, wherein a contact area disposed over the majority of the semi-conductive oxide layer area is deposited by any of thermal spraying techniques, physical and chemical vapour deposition in a vacuum, evaporated metals using electron beam or thermal techniques, electro less and electrolytic processes and mechanical pressure methods.

29. A method as claimed in any of claims 16 to 28, wherein the alloy is a binary alloy consisting of two metals only.

30. A resistive heating element as claimed in any of claims 1 to 15, wherein the alloy is a binary alloy consisting of two metals only.
